(19) United States
(12) Patent Application Publication
(10) Pub. No.: US 2010/0274570 A1
(43) Pub. Date: Oct. 28, 2010

(54) VEHICLE CHARGING AUTHORIZATION

(75) Inventors: DAVID T. PROEFKE, MADISON HEIGHTS, MI (US); WILLIAM A. BIONDO, BEVERLY HILLS, MI (US); CLARK E. MCCALL, ANN ARBOR, MI (US); JEFFREY W. BROWN, HAMPTON, (AU); FRED W. HUNTZICKER, ANN ARBOR, MI (US); ANSAF I. ALRABADY, LIVONIA, MI (US); MIKE M. MCDONALD, MACOMB, MI (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 12/429,747

(22) Filed: Apr. 24, 2009

(51) Int. Cl. G06F 19/00; G06Q 30/00; G06F 1/26; G05B 19/00

(52) U.S. Cl. 705/1.1; 701/22; 700/295; 340/5.54

(57) ABSTRACT

Methods and apparatus are provided for charging an onboard energy storage system of a plug-in vehicle using a charging station. An embodiment of the system includes a vehicle communication system configured to transmit data related to charging authorization to the charging station. The embodiment also includes an electronic device configured to communicate with the vehicle communication system within a set range from the plug-in vehicle; and a vehicle controller communicatively coupled to the vehicle communication system. The vehicle controller is configured to direct the vehicle communication system to transmit the data related to charging authorization if the electronic device is within the set range from the plug-in vehicle.

### TECHNICAL FIELD

The following disclosure generally relates to charging plug-in vehicles including electric and plug-in hybrid-electric vehicles, and more particularly relates to charging authorization systems and methods.

### BACKGROUND

Plug-in electric vehicles such as plug-in hybrid electric and range-extended vehicles have an onboard energy storage system that can be charged from a wall outlet or other utility power source. The onboard energy storage system is used to propel the vehicle and is recharged regularly. Many households have the ability to charge the onboard energy storage system in a secure location such as a garage. Many other settings, however, do not have access to a wall outlet where a plug-in vehicle can be charged in a secure location. In some cases, a power extension cord could be used in an unsecured area, but this may allow other people to charge their vehicles' onboard energy storage systems without permission, resulting in high costs for electricity used by other people.

Accordingly, it is desirable to provide systems with secure charging in an unsecured area. In addition, it is desirable to provide secure exchange of information for a vehicle charging transaction in an unsecured area. Furthermore, other desirable features and characteristics will become apparent from the subsequent detailed description and the appended claims, taken in conjunction with the accompanying drawings and the foregoing technical field and background.

### SUMMARY

A system is provided for charging an onboard energy storage system of a plug-in vehicle using a charging station. An embodiment of the system comprises a vehicle communication system configured to transmit data related to charging authorization to the charging station. The embodiment also includes an electronic device configured to communicate with the vehicle communication system within a set range from the plug-in vehicle; and a vehicle controller communicatively coupled to the vehicle communication system. The vehicle controller is configured to direct the vehicle communication system to transmit the data related to charging authorization if the electronic device is within the set range from the plug-in vehicle.

Another system is provided for charging an onboard energy storage system of a plug-in vehicle. An embodiment of the system comprises a station communication system configured to receive data related to charging authorization from the plug-in vehicle; and a power flow switch configured to regulate electrical power for charging the onboard energy storage system. The embodiment also includes a database including identification data related to plug-in vehicles authorized to charge at a charging station; and a controller communicatively coupled to the station communication system and to the database. The controller is configured to direct the power flow switch to allow charging of the onboard energy storage system if the data related to charging authorization corresponds to the identification data in the database.

A method is provided for charging an onboard energy storage system for a plug-in vehicle using a charging station. An embodiment of the method comprises receiving, from the charging station, a request for charge authorization information; and transmitting a signal to an electronic device. If a response signal is received from the electronic device, the embodiment includes transmitting the charge authorization information to the charging station.

### DESCRIPTION OF THE DRAWINGS

A more complete understanding of the subject matter may be derived by referring to the detailed description and claims when considered in conjunction with the following figures, wherein like numerals denote like elements, and

FIG. 1 is a diagram of a system for charging an onboard storage system of a plug-in vehicle using a charging station;

FIG. 2 is a flow chart of an exemplary method of charging an onboard energy storage system from the perspective of the plug-in vehicle; and

FIG. 3 is a flow chart of an exemplary method of charging an onboard energy storage system from the perspective of the charging station.

### DESCRIPTION OF AN EXEMPLARY EMBODIMENT

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

When charging a plug-in vehicle in a public area, one method of charging is to use a pay-per-charge station that carries out a financial transaction as a condition of supplying power to recharge the onboard energy storage system. The pay-per-charge station can have a credit card terminal where the driver approves the financial transaction. Another method that may save time for the driver is for the plug-in vehicle to store credit card information and to transmit the information to the pay-per-charge station. To protect the credit card information, one embodiment verifies that the plug-in vehicle operator is present prior to transmitting to the charging station, thereby allowing the plug-in vehicle operator to oversee the transfer of private information. One verification method is for the vehicle to determine that an electronic device such as a key fob or cell phone is near the vehicle prior to transmitting the credit card information. The vehicle may transmit a signal to the electronic device, and if the electronic device is within a set range around the vehicle, the electronic device can respond with authorization. This may prevent theft of the credit card information by ensuring that the information is only sent when a trusted party is nearby. The vehicle may also store other types of private or financial account information that are transmitted to the charging station.

Other types of charging stations in unsecured or public areas may be semi-private charging stations that only allow pre-authorized vehicles to charge. Charging stations in an office building parking lot or at an apartment complex, for example, may allow tenants to charge their vehicles while excluding vehicles belonging to others. The semi-private charging stations may be connected to a database that includes identification data for all of the authorized vehicles. In an exemplary embodiment the charging station requests authorization information from a vehicle when connected for charging. If the vehicle responds with information that is in the database indicating that it is an authorized vehicle, then the charging station supplies power for charging the onboard energy storage system. This system may allow for a charging station in an unsecured area that is reserved for the exclusive use of authorized. As with the pay-per-charge station, the vehicle may verify that a vehicle operator is present before transmitting identification data as a method to prevent the theft of credit card or other private information by devices posing as charging stations in order to extract this private information.

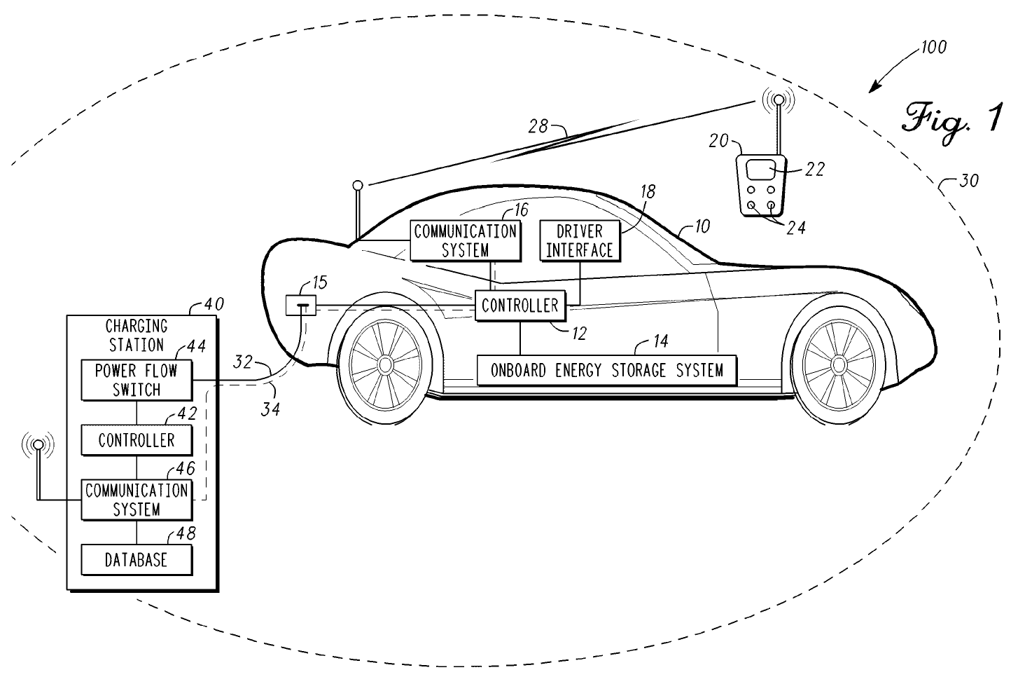

FIG. 1 shows an exemplary charging system 100 including a plug-in vehicle 10, an electronic key fob 20, and a charging station 40. Plug-in vehicle 10 may include a vehicle controller 12, an onboard energy storage system 14, a vehicle communication system 16, and/or a driver interface 18. Exemplary electronic key fob 20 includes a fob display 22 and fob input keys 24. Charging station 40 may include a station controller 42, a power flow switch 44, a station communication system 46, and a database 48. In the exemplary charging system 100 a power supply cable 32 and a data cable 34 are connected between charging station 40 and a charging port 15 on plug-in vehicle 10.

Plug-in vehicle 10 is any vehicle that regularly recharges a power source by plugging-in to an electrical outlet. Vehicle controller 12 is any system that controls the process of recharging the power source on plug-in vehicle 10. Vehicle controller 12 may include a single processor in a single system, or it may include multiple processors in different systems that are coupled together. In the exemplary embodiment vehicle controller 12 is coupled to onboard energy storage system 14, vehicle communication system 16 and driver interface 18.

Onboard energy storage system 14 is any power source on plug-in vehicle 10 that is designed to be regularly recharged through an external electrical power source. Plug-in vehicle 10 may be a pure-electric, or a hybrid-electric vehicle with onboard energy storage system 14 providing power for propelling the vehicle.

Vehicle communication system 16 is any communication system capable of communicating with electronic key fob 20. Vehicle communication system 16 may communicate with charging station 40 using a wired or a wireless connection. In an exemplary embodiment, vehicle communication system includes a radio frequency device for transmitting and receiving short range radio frequency signals from electronic key fob 20. In alternative embodiments, other electronic devices may be used to perform the functions discussed for electronic key fob 20, including cell-phones, BLUETOOTH™ or other IEEE 802.x enabled devices, proprietary wireless communication devices, or other suitable communication devices.

Driver interface 18 is any system capable of providing information to a driver, and of receiving input from the driver. In an exemplary embodiment, driver interface 18 is a touch-screen display that displays images and words, and that also accepts input from the driver touching the screen. In other embodiments the information may be provided as audible prompts through speakers, and/or received as voice commands from the driver through a microphone. Other devices such as key pads, buttons, knobs, displays and the like may be used for driver interface 18.

Key fob 20 is any device that is configured for wireless communication with vehicle communication system 16. In an exemplary embodiment key fob 20 receives and transmits a short range radio frequency band signal, although other types of wireless communication may also be used. Key fob 20 may have a display 22 that displays communication from vehicle communication system 16 and status of plug-in vehicle 1O. In the exemplary embodiment key fob 20 includes input keys 24 that are used to operate key fob 20 and/or to input commands to be sent to vehicle communication system 16, such as remote operation of doors, and other vehicle settings or features. In an exemplary embodiment key fob 20 is used to identify a specific driver of plug-in vehicle 10. Key fob 20 may also be used to communicate with charging station 40 and/or other systems. In various embodiments, key fob 20 is any sort of computing device, PDA, cell phone or other electronic device that is capable of performing the features described in this document.

Charging station 40 is any system designed to deliver electrical power to plug-in vehicle 10, and to control access to the electrical power. In an exemplary embodiment charging station 40 is a public charging station that requires payment for recharging onboard energy storage system 14. In another embodiment charging station limits use to a predetermined group of plug-in vehicles.

Power flow switch 44 in charging station 40 is any device for controlling the power delivered to plug-in vehicle 10 for recharging onboard energy storage system 14. In an exemplary embodiment power flow switch 44 is an electrical relay that connects plug-in vehicle 10 with a power source when charging is authorized.

Station controller 42 is any system that controls the process of supplying power from a power source to recharge plug-in vehicle 10. Station controller 42 may include a single processor in a single system, or it may include multiple processors in different systems that are coupled together. In the exemplary embodiment station controller 42 is coupled to power flow switch 44, station communication system 46 and database 48. Station controller 42 may be configured to compare information received from plug-in vehicle 10 with information identifying plug-in vehicles authorized to receive power from charging station 40. The information identifying the authorized vehicle may include a vehicle identification number (VIN) and/or other codes to identify the vehicle.

Station communication system 46 is any system configured to communicate with plug-in vehicle 10. In one embodiment station communication system 46 also communicates with financial institutions to obtain approval for financial transactions. Data cable 34 may connect station communication system 46 to charging port 15, and to vehicle controller 12.

Database 48 is any non-volatile data storage system coupled to station controller 42. Database 48 is accessible to charging station in any suitable manner. In an exemplary embodiment database 48 is stored in a data storage device that is part of charging station 40. In other embodiments database 48 is a database accessible to station controller 42 though data communication networks. Database 48 may be implemented in any suitable manner such as a database coupled to a server with lookup tables. Database 48 may include user profiles that are updated each time a plug-in vehicle associated with the user profile is recharged using a charging station linked to database 48. In one embodiment database 48 stores indicators for allowing varying levels of authorization. Database 48, for example, may have indicators that allow some vehicles to charge without billing an account for the cost of power used or other costs, while other vehicles may have associated accounts that are debited at various rates depending on the indicators in database 48. Other indicators may limit charging to certain amounts, times, dates, and/or limit a plug-in vehicle to recharge at specific charging stations to prevent unauthorized use of charging station 40.

The communication between charging station 40 and plug-in vehicle 10 is accomplished in any suitable manner. In one embodiment charging port 15 includes a switch for indicating that a charging cable is connected; vehicle controller 12 and/or other systems are turned on when power supply cable is detected by the switch. In another embodiment a signal is sent through data cable 34 directing vehicle controller 12 to power on. As another feature, power supply cable 32 may be used to power on vehicle controller 12 and/or other systems, for example, by sending a pulse of power through power supply cable 32.

With vehicle controller 12 and other systems such as vehicle communication system 16 powered on, communications may be established between vehicle controller 12 and station controller 42 in any suitable manner. In an exemplary embodiment, communication between vehicle controller 12 and station controller 42 is established through data cable 34 with vehicle communication system 16 linked to station communication system 46. Alternatively, communications may be established through a wireless connection between vehicle communication system 16 and station communication system 46. Data transfer may be through any suitable wireless or wired data format.

In the exemplary embodiment charging station 40 is a public charging station that requests payment information as authorization information to pay for power used to recharge onboard energy storage system 14. Authorization information may include such information as vehicle identification, driver identification, financial account information such as a checking or credit account number, an access code to access financial account information, and/or other information as appropriate. In other embodiments other types of information are used as authorization information to allow charging station 40 to approve charging of onboard energy storage system 14, and/or to debit an account to pay for power used. A charge authorization from plug-in vehicle may include limitations on the cost for charging such as a dollar amount, and/or limitations on the power consumption such as a kWh limit or a percentage of charge of onboard energy storage system 14.

In the exemplary embodiment when station controller 42 in charging station 40 determines that charging is authorized, station controller 42 directs power flow switch 44 to supply power to plug-in vehicle 1O. Power flow switch 44 may include a sensor that measures power usage, and the measured power usage may be stored in database 48.

In another embodiment charging station 40 is a semi-private charging station that allows pre-authorized users or vehicles to charge. A list of authorized vehicles, for example, may be stored in database 48. In the exemplary embodiment, station communication system 46 communicates with vehicle communication system 16 using an IEEE 802.x communication standard with known secure communication methods. Station controller 42 receives the charging authorization information including vehicle identification from vehicle controller 12 and compares the information with the list of authorized vehicles in database 48. If station controller 42 determines that a vehicle connected to power supply cable 32 is authorized, then a signal is sent to direct power flow switch 44 to supply power for charging. In this embodiment charging station 40 may track power usage and store the power usage in database 48 for later billing and/or for other purposes.

In the exemplary embodiment, plug-in vehicle 10 verifies authorization prior to transmitting (or allowing access to) authorization data. This may prevent the unauthorized use of charging station 40. Verifying authorization may also prevent the theft and use of authorization information such as the use of financial account information for other unauthorized transactions. Authorization is verified to ensure that charging is authorized by a vehicle operator and may be active or passive. In an exemplary embodiment passive charging verification is initiated when a physical connection is detected using a switch in charging port 15. A low power signal 28 may be transmitted from vehicle communication system 16 to key fob 20 to verify that the vehicle operator is near plug-in vehicle 10. In this example if key fob 20 is within set range 30, key fob 20 will receive low power signal 28 and automatically return a response signal to vehicle communication system 16 as verification of charging authorization. If key fob 20 is not within set range 30 when charging verification is determined, however, plug-in vehicle appropriately ends the charge authorization process, or seeks to verify charge authorization in another manner.

In an exemplary embodiment key fob 20 stores vehicle-owner information as well as vehicle-specific information and/or other information used for authorization. A response from key fob 20 to a verification request may provide charging authorization information to plug-in vehicle 10. In one embodiment a vehicle driver is prompted on display 22 to authorize vehicle charging.

When charging plug-in vehicle 10 with a charging station that carries out a financial transaction for each charging cycle, the vehicle driver may limit charging authorization in any suitable manner. Charging may be authorized, for example, up to a specific cost limit, up to a specific electrical unit, and up to a percentage of charge of onboard energy storage system 14. In an illustrative example, a vehicle operator sets a predefined limit on charging and only authorizes vehicle charging upto a cost per KWhr of $0.11/KWhr. In this example the vehicle operator also sets a predefined authorization limit as to the total cost of a charging cycle.

In the exemplary embodiment where key fob 20 is used for charging verification, vehicle controller 12 determines whether key fob 20 is within set range 30 in any suitable manner. As discussed above, vehicle communication system 16 transmits a signal 28 with a limited range and receives a reply from key fob 20 when key fob 20 is within set range 30,. In another embodiment key fob 20 is configured to determine the strength of a verification transmission signal 28 from vehicle communication system 16, and to reply with approval only if the strength of the signal 28 indicates that key fob 20 is within set range of vehicle. Alternatively, key fob 20 includes position-tracking capabilities to determine a current location of electronic key fob 20. A key fob that is a cell phone, for example, may have a GPS receiver, or may track positions from cell towers to determine a location. Plug-in vehicle 10 may also have position-tracking capabilities to determine a location. Location information from key fob 20 and plug-in vehicle 10 may be compared to determine if key fob 20 is within set range 30 of plug-in vehicle 10. In an alternative embodiment, vehicle communication system 16 transmits a verification signal 28 to key fob 20 including the position of plug-in vehicle 10. Key fob 20 then receives the signal and determines a distance and replies with authorization if the distance is less than set range 30. Alternatively a distance determination may be made by vehicle controller 12. Vehicle communication system 16, for example, may receive a response from key fob 20 indicating a position, and vehicle controller 16 may compare the key fob position to the vehicle position to determine if key fob 20 is within set range 30. In addition to the exemplary methods described above, other methods may be used to determine if key fob 20 is within set range 30 for verification of charging authorization.

Other methods of verification of charging authorization may be used in addition to, or as alternative methods to those described above. An active verification, rather than a passive verification, may also be used. In an exemplary embodiment that provides active verification, a verification signal 28 sent to key fob 20 from vehicle communication system 16 includes a requests for an affirmative response. A key fob user presses one or more input keys 24 prior to key fob 20 transmitting vehicle authorization information to charging station 40. An active verification request may be sent to key fob 20, for example, if a response is not received by vehicle communication system after a passive verification attempt. In the example, the passive verification attempt is sent with a low power transmission, and then the active verification attempt is sent with a full power transmission if there is no response to the passive verification attempt. This may allow a vehicle operator to be alerted to an attempt to access vehicle authorization information when they are not present, and/or to respond with active verification input if the passive verification fails.

Verification may also be received through driver interface 18. Vehicle controller 12 can direct driver interface 18 to prompt a vehicle user for a password such as a pin or other code. If the password matches a password stored in memory, then plug-in vehicle transmits the authorization information to charging station 40. As with other verification methods, this method may be used as a primary verification method or as a secondary verification method when another verification method fails.

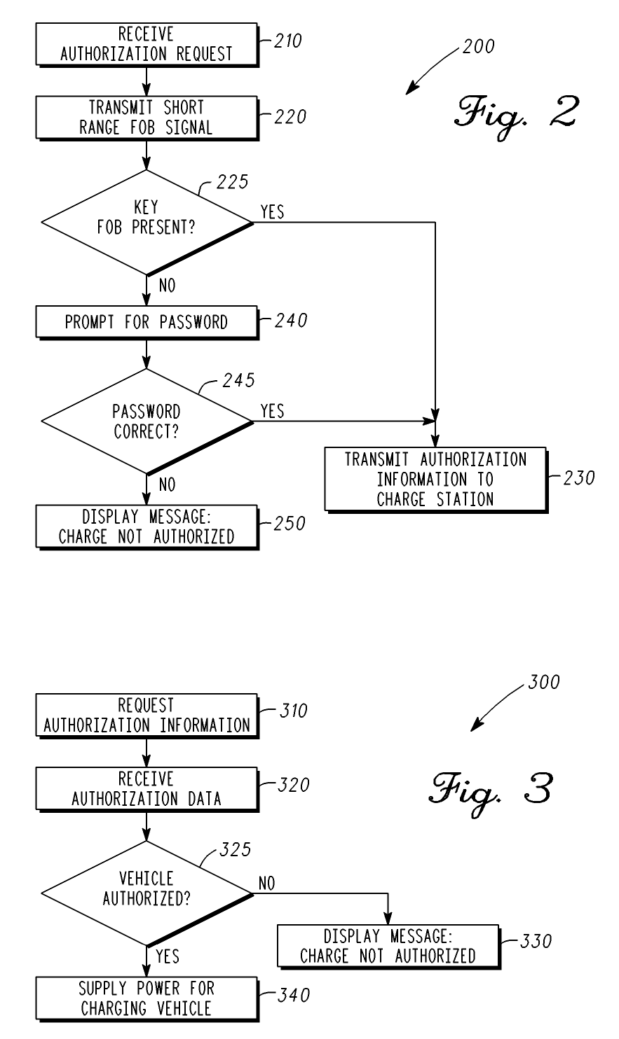

Turning now to FIG. 2, an exemplary method 200 for charging an onboard energy storage system of a plug-in vehicle suitably includes the broad functions of receiving an authorization request (function 210) from a charging station, transmitting a short range fob signal (function 220) to a key fob, and transmitting authorization information to the charging station (function 230). Other embodiments may additionally prompt for a password (function 240) when a key fob is not present near the plug-in vehicle and/or may display a message indicating that charging is not authorized (function 250) as appropriate. Various other functions and other features may also be provided, as described in increasing detail below.

Generally speaking, the various functions and features of method 200 may be carried out with any sort of hardware, software and/or firmware logic that is stored and/or executed on any platform. Some or all of method 200 may be carried out, for example, by logic executing within vehicle controller 12 in FIG. 1. In one embodiment, vehicle controller 12 executes software logic that performs each of the various functions shown in FIG. 2. Such logic may be stored in memory that is part of vehicle controller 12 or in any other storage available to vehicle controller 12 as desired. Hence, the particular logic and hardware that implements any of the various functions shown in FIG. 2 may vary from context to context, implementation to implementation, and embodiment to embodiment in accordance with the various features, scenarios and structures set forth in this application. The particular means used to implement each of the various functions shown in FIG. 2, then, could be any sort of processing structures that are capable of executing conventional software logic in any format. Such processing hardware may include a processor in vehicle controller 12, a processor in key fob 20 and/or other components of charging system 100 in FIG. 1, as well as any other processors or other components associated with any conventional plug-in vehicle, key fob, charging station and/or the like.

As discussed above, vehicle controller 12 (FIG. 1) may receive a request for charging authorization information (function 210) in any suitable manner. Charging station 40, for example, may request authorization to debit a financial account, and/or may request identification information prior to allowing a charge of onboard energy storage system 14. The request for charging authorization information may be received through a wireless transmission or a transmission over any suitable wired connection. The charging authorization information request is initiated in any suitable manner. Plug-in vehicle 10, for example, may sense or determine that power supply cable 32 is connected and send a request to charging station 40 for a charge. In this example the received request for charging authorization information (function 210) is in response to the charge request from plug-in vehicle 10. In another embodiment charging station 40 senses or determines that a charge of onboard energy storage system 14 is desired, and initiates the request for charging authorization information.

As discussed above, a verification process may be used prior to sending the requested charging authorization information to charging station 40 (FIG. 1). In exemplary method 200 a short range signal 28 is sent to key fob 20 (function 220) to verify that key fob 20, and therefore a vehicle operator is near plug-in vehicle 10. Based on a response signal from key fob 20, controller may determine if key fob 20 is present (function 225). In the exemplary embodiment if key fob 20 is within set range 30, key fob 20 receives the short range signal 28 and replies with a response. In other embodiments key fob 20 may respond if is it not within set range 30 with information that indicates that it is outside of set range 30. In one embodiment the charging authorization information is stored on key fob 20 in a memory module, and the response signal from key fob 20 contains some or all of the charging authorization information requested for authorizing charging from charging station 40.

When the exemplary verification process determines that the vehicle operator is present, the charging authorization information is transmitted to charging station 40 (function 230). In an exemplary embodiment the charging authorization information is stored in non-volatile memory connected to (or part of) vehicle controller 12. Alternatively, some or all of the charging authorization information may be stored in key fob 20 and transmitted to temporary memory storage in vehicle controller 12 before transmission to charging station 40 (function 230). The transmission of the charging authorization information (function 230) in the exemplary embodiment is through the same method used to receive the charging authorization request (function 210). In other embodiments, however, the transmission of the charging authorization information (function 230) is through a different method. The transmission of charging authorization information may be through a wired or a wireless connection between plug-in vehicle 10 and charging station 40.

In exemplary method 200, when vehicle controller 12 (FIG. 1) determines that key fob 20 is not present (function 225), a secondary verification method is used to verify that charging is authorized by a vehicle operator. A secondary verification method, for example, may be prompting the vehicle operator for a password (function 240), and comparing the input password to a stored password to determine if the password is correct (function 245). The prompt for a password (function 240) may be through driver interface 18, display 22 on key fob 20, and/or through other systems. In other embodiments other secondary verification methods may be used, such as requiring an active response from vehicle operator using key fob 20.

In exemplary method 200, if the secondary verification method determines that charging is authorized, then charging authorization information is transmitted to the charging station (function 230). If, however, the secondary verification method does not determine that charging is authorized, a message may be displayed that charging is not authorized (function 250). As with the prompt for a password (function 240) the display of the message that charging is not authorized (function 250) may be performed in any suitable manner.

Turning now to FIG. 3, an exemplary method 300 for charging an onboard energy storage system of a plug-in vehicle suitably includes the broad functions of requesting authorization information (function 310) from plug-in vehicle 10 (FIG. 1), receiving authorization data (function 320) from plug-in vehicle 10, and supplying power for charging plug-in vehicle (function 340). Other embodiments may determine if plug-in vehicle 10 is authorized for receiving power (function 325) and/or may display a message indicating that charging is not authorized (function 330) as appropriate. Various other functions and other features may also be provided, as described in increasing detail below.

Generally speaking, the various functions and features of method 300 may be carried out with any sort of hardware, software and/or firmware logic that is stored and/or executed on any platform. Some or all of method 300 may be carried out, for example, by logic executing within station controller 42 in FIG. 1. In one embodiment, station controller 42 executes software logic that performs each of the various functions shown in FIG. 3. Such logic may be stored in memory that is part of station controller 42 or in any other storage available to station controller 42 as desired. Hence, the particular logic and hardware that implements any of the various functions shown in FIG. 3 may vary from context to context, implementation to implementation, and embodiment to embodiment in accordance with the various features, scenarios and structures set forth in this application. The particular means used to implement each of the various functions shown in FIG. 3, then, could be any sort of processing structures that are capable of executing conventional software logic in any format. Such processing hardware may include a processor in station controller 42, and/or other components of charging system 100 in FIG. 1, as well as any other processors or other components associated with any conventional charging system, network, database server and/or the like.

Charging station 40 (FIG. 1) may request authorization information (function 310) in any manner. As discussed above, charging station 40 may request account information such as a credit card account or a bank account so that costs and or charges associated with providing power to charge plug-in vehicle 10 can be paid. In other embodiments authorization information may be used to verify that a plug-in vehicle is pre-authorized to receive power from charging station 40.

In exemplary method 300, authorization data is received (function 320) from plug-in vehicle 10 (FIG. 1) in any manner. The authorization data, for example, may be received as encrypted data to prevent unauthorized access to financial account information and/or other private information. In the exemplary embodiment station controller 42 uses the authorization data to determine if plug-in vehicle 10 is authorized to receive power (function 325). As discussed above, the authorization data may be account information approving a financial transaction, and determining authorization to provide power (function 325) may include contacting a financial institution to verify account information and/or available funds for payment. In another embodiment the authorization data is used to determine if plug-in vehicle 10 has been pre-authorized to receive power by comparing the authorization data to pre-authorization data in database 48. Other methods may be used to determine if plug-in vehicle 10 is authorized to receive power (function 325).

In exemplary method 300 if station controller 42 (FIG. 1) determines that plug-in vehicle is authorized to receive power (function 325) a signal is sent to power flow switch 44 to supply power to plug-in vehicle 10. If, however, station controller 42 determines that plug-in vehicle is not authorized to receive power (function 325), then station controller 42 may direct a message on a display to indicate that charging is not authorized (function 330).

Power may be supplied to plug-in vehicle 10 (function 340) in any manner. Power may be supplied, for example, continuously until charging is complete, in intervals, based on demand at a local or regional level, based on power rates, and/or in other ways. Power may be supplied at any suitable voltage level that can be received by plug-in vehicle 10, and with any suitable power connectors and/or devices.

A message from charging station 40 (FIG. 1) may be displayed in any manner. In one embodiment of method 300, if station controller 42 determines that charging is not authorized (function 325), a message is transmitted to plug-in vehicle 10, and displayed (function 330) on driver interface 18 and is transmitted to key fob 20, and displayed on display 22. In other embodiments charging station 40 has a station display that displays the message when charging is not authorized (function 330). Any other suitable methods of displaying or communicating messages may also be used.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A system for charging an onboard energy storage system of a plug-in vehicle using a charging station, the system comprising:
a vehicle communication system configured to transmit data related to charging authorization to the charging station;
an electronic device configured to communicate with the vehicle communication system within a set range from the plug-in vehicle; and
a vehicle controller communicatively coupled to the vehicle communication system and configured to direct the vehicle communication system to transmit the data related to charging authorization if the electronic device is within the set range from the plug-in vehicle.

2. A system according to claim 1, wherein the vehicle communication system detects whether the electronic device is within the set range and wherein the vehicle controller prevents transmission of the data related to charging authorization if the electronic device is not detected within the set range.

3. A system according to claim 1 wherein the system includes a charging station comprising:
a station communication system configured to receive the data related to charging authorization from the plug-in vehicle;
a power flow switch configured to regulate electrical power for charging the onboard energy storage system;
a database including identification data related to plug-in vehicles authorized to charge at the charging station; and
a station controller communicatively coupled to the station communication system and to the database, the station controller configured to direct the power flow switch to allow charging of the onboard energy storage system if the data related to charging authorization corresponds to the identification data in the database.

4. A system according to claim 3 further comprising a charging cable coupled to the charging station and configured to provide the electrical power for charging the onboard energy storage system.

5. A system according to claim 4 wherein the charging cable is configured to couple the station communication system to the vehicle controller.

6. A system according to claim 1 wherein the vehicle communication system includes a short range wireless transmitter for communication with the electronic device.

7. A system according to claim 1 further comprising a vehicle driver interface device coupled to the vehicle controller, wherein the vehicle communication system detects whether the electronic device is within the set range and wherein the vehicle controller prompts a vehicle driver for a password through the vehicle driver interface device, if the electronic device is not detected within the set range.

8. A charging system for charging an onboard energy storage system of a plug-in vehicle, the charging system comprises:
a station communication system configured to receive data related to charging authorization from the plug-in vehicle;
a power flow switch configured to regulate electrical power for charging the onboard energy storage system;
a database including identification data related to plug-in vehicles authorized to charge at a charging station; and
a controller communicatively coupled to the station communication system and to the database, the controller configured to direct the power flow switch to allow charging of the onboard energy storage system if the data related to charging authorization corresponds to the identification data in the database.

9. A charging system according to claim 8 wherein the station communication system is configured to establish a secure communication link with the plug-in vehicle.

10. A charging system according to claim 8 wherein the plug-in vehicle comprises:
a vehicle communication system configured to transmit data related to charging authorization to the station communication system; and
an authentication system configured to verify presence of a vehicle operator prior to transmitting of the data related to charging authorization to the station communication system.

11. A charging system according to claim 8 wherein the controller is configured to direct the power flow switch to supply a pulse of electrical power to the plug-in vehicle to activate the plug-in vehicle prior to receiving the data related to charging authorization.

12. A method of charging an onboard energy storage system for a plug-in vehicle using a charging station, the method comprising:
transmitting a signal to an electronic device; and
if a response signal is received from the electronic device, transmitting charge authorization information to the charging station.

13. A method according to claim 12 further comprising detecting a charging cable connected to the plug-in vehicle, and activating the onboard energy storage system in response to the detecting of the charging cable.

14. A method according to claim 12 wherein the transmitting of the signal to the electronic device includes encrypting the signal prior to transmitting.

15. A method according to claim 12 wherein the response signal from the electronic device includes the charge authorization information.

16. A method according to claim 12 wherein the transmitting of the charge authorization information to the charging station includes transmitting vehicle identification information.

17. A method according to claim 12 wherein the transmitting of the charge authorization information to the charging station includes transmitting financial account information.

18. A method according to claim 12 wherein the transmitting of the charge authorization information to the charging station includes transmitting authorization codes to access financial account information in a remote database.

19. A method according to claim 12 wherein the charging station includes a power flow switch configured to regulate charging of the onboard energy storage system, and a database containing identification data related to plug-in vehicles authorized to charge at the charging station, the method comprising:
receiving, from the plug-in vehicle, the charge authorization information;
if the charge authorization information corresponds to the identification data in the database, regulating the power flow switch to allow charging of the onboard energy storage system.

20. A method according to claim 12 wherein if a response signal is not received from the electronic device, prompting a vehicle driver for a password, and verifying the password prior to transmitting the charge authorization information to the charging station.
